(19) United States
(12) Patent Application Publication
(10) Pub. No.: US 2025/0157687 A1
(43) Pub. Date: May 15, 2025

(54) SILVER NANOMATERIALS

(71) Applicant: Iowa State University Research Foundation, Inc., Ames, IA (US)

(72) Inventors: Fei Liu, Ames, IA (US); Shan Jiang, Ames, IA (US)

(21) Appl. No.: 18/938,134

(22) Filed: Nov. 5, 2024

Related U.S. Application Data
(60) Provisional application No. 63/597,568, filed on Nov. 9, 2023.

(51) Int. Cl. H01B 1/02; B82Y 30/00; B82Y 40/00; H01B 5/02

(52) U.S. Cl. CPC H01B 1/02; H01B 5/02; B82Y 30/00; B82Y 40/00

(57) ABSTRACT

A silver nanomaterial includes silver nanowires, or a particulate silver nanomaterial such as silver bipyramids, silver nanocubes, or faceted silver nanoparticles, stabilized with cellulose or a cellulose derivative. A method of making a silver nanomaterial includes forming a reaction solution including cellulose or a cellulose derivative and a silver nanomaterial precursor to form the silver nanomaterial.

### CROSS-REFERENCE TO RELATED APPLICATION

This application claims the benefit of priority to U.S. Provisional Patent Application Ser. No. 63/597,568 filed Nov. 9, 2023, the disclosure of which is incorporated herein in its entirety by reference.

### STATEMENT OF GOVERNMENT SUPPORT

This invention was made with Government support under 80NSSC21M0360 awarded by NASA. The Government has certain rights in the invention.

### BACKGROUND

Silver nanostructures can have a wide range of sizes, shapes, and morphologies and have gained significant attention due to their unique properties and versatile applications in various fields. Among all the silver nanostructures, silver nanowires exhibit excellent electrical conductivity, thermal conductivity, and mechanical flexibility, making them candidates for replacing conventional indium tin oxide in transparent conductive films. Their unique optical property originating from the local surface plasmon effect also allows for many important applications in surface-enhanced Raman spectroscopy and photothermal therapy. Additionally, other silver nanostructures, such as bipyramids, present distinct optical and surface properties, leading to different performance in applications.

However, conventional syntheses of silver nanostructures mostly rely on polyvinylpyrrolidone (PVP). Particularly, the synthesis of silver nanowires is limited by the approach using PVP. Additionally, conventional approaches to silver nanostructures use or generate toxic or hazardous materials, and are expensive.

### SUMMARY OF THE INVENTION

In various aspects, the present invention provides a silver nanomaterial including silver nanowires, or a particulate silver nanomaterial such as silver bipyramids, silver nanocubes, or faceted silver nanoparticles, stabilized with cellulose or a cellulose derivative.

In various aspects, the present invention provides a silver nanomaterial stabilized with cellulose or a cellulose derivative, the silver nanomaterial including chloride ions and bromide ions having a chloride:bromide molar ratio of 10:1 to 1:10.

In various aspects, the present invention provides a silver nanomaterial including silver nanowires stabilized with hydroxyethyl cellulose. The nanowires have a length of at least 1 micron and a diameter of 20 nm to 500 nm.

In various aspects, the present invention provides a particulate silver nanomaterial such as silver bipyramids, silver nanocubes, or faceted silver nanoparticles, stabilized with cellulose or a cellulose derivative. The particulate silver nanomaterial has a largest dimension of 20 nm to 500 nm.

In various aspects, the present invention provides a silver nanomaterial including a reaction product of a composition including a silver precursor, cellulose or a cellulose derivative, and halide ions.

In various aspects, the present invention provides a silver nanomaterial that includes a reaction product of a composition that includes silver nitrate, hydroxyethyl cellulose, a bromide salt, and a chloride salt. The silver nanomaterial can include a silver nanowire, or a particulate silver nanomaterial such as a silver bipyramid, silver nanocube, or a faceted silver nanoparticle.

In various aspects, the present invention provides a conductive film that includes the silver nanomaterial described herein. The conductive film can be a transparent conductive film.

In various aspects, the present invention provides a method of making the silver nanomaterial described herein. The method includes forming a reaction solution including cellulose or a cellulose derivative and a silver nanomaterial precursor to form the silver nanomaterial.

In various aspects, the present invention provides a method of making a silver nanomaterial. The method includes heating a reaction solution including a solvent, hydroxyethyl cellulose, silver nitrate, a bromide salt, and a chloride salt and a silver nanomaterial precursor to a temperature of 110° C. to 140° C. to form the silver nanomaterial. The reaction solution has a ratio of chloride ions to bromide ions of 10:1 to 1:10. The silver nanomaterial includes a silver nanowire having a length of at least 1 micron and a diameter of 20 nm to 500 nm or a particulate silver nanomaterial such as a silver bipyramid, silver nanocube, or a faceted silver nanoparticle having a largest dimension of 20 nm to 500 nm.

In various aspects, the present invention provides a silver nanomaterial including a reaction product of a reaction solution including silver nitrate, a solvent, hydroxyethyl cellulose, and a bromide salt and a chloride salt, wherein the reaction solution has a ratio of chloride ions to bromide ions of 3:1 to 1:3.

Various aspects of the nanomaterial of the present invention and methods of making the same have various advantages over conventional silver nanomaterials and methods of making the same. For example, in various aspects, the present method can form silver nanomaterials such as nanowires, bipyramids, nanocubes, or faceted nanoparticles without the use of PVP. In various aspects, the present method can form silver nanomaterials using cellulose or any of a variety of cellulose derivatives. The cellulose or cellulose derivative can be biobased and can act as both a reducing agent that forms silver from a silver nanomaterial precursor and as a stabilizer that stabilizes that nanomaterial formed. In various aspects, the present method can be more efficient (e.g., fewer processing steps), environmentally-friendly, and cost-effective than other methods of forming silver nanomaterials, such as methods that include the use of PVP. In various aspects, the present method can form silver nanomaterials with less or no use or production of toxic materials. In various aspects of the present method, the morphology of the silver nanomaterial obtained can be controlled and tuned by varying the ratio of halides in the reaction solution and/or by varying the overall concentration of halides in the reaction solution.

Silver nanowires are of particular interest because they can be used to make a transparent conductive film which can be utilized in various technologies such as smartphones, solar cells, transparent electronics, flexible electronics, sensing applications, or a combination thereof. Transparent and conductive films are essential to numerous technologies such as touchscreens and photovoltaics. One of the most common materials used is indium tin oxide which suffers from high production cost and the critical supply of indium. Various aspects of the silver nanomaterials of the present invention represent a potential replacement for some applications following a cheap and green synthesis. Various aspects of the present method provide longer silver nanowires than formed via other methods, such as methods including the use of PVP. Various aspects of the present method provide silver nanowires using more mild conditions than other methods, such as methods that include the use of PVP which is typically more expensive than HEC. Various aspects of the present method provide silver nanowires having a larger aspect ratio (length over diameter) than possible with PVP, thereby providing higher performance silver nanowires than methods including the use of PVP. Various aspects of the present method provide a thin film including silver nanowires that has a lower sheet resistance and/or a higher transmittance as compared to thin films prepared from other silver nanowires.

### BRIEF DESCRIPTION OF THE FIGURES

The drawings illustrate generally, by way of example, but not by way of limitation, various aspects of the present invention.

FIG. 1 illustrates a schematic diagram of silver nanowire synthesis with HEC, in accordance with various aspects.

FIG. 2A illustrates a SEM image of silver nanowires synthesized with HEC, in accordance with various aspects.

FIG. 2B illustrates a SEM image of silver nanowires synthesized with HPC, in accordance with various aspects.

FIG. 3A illustrates a SEM image of silver nanostructures synthesized with HEC at a concentration of 0 mg/mL, with NaCl and KBr concentrations at 4 mM, in accordance with various aspects.

FIG. 3B illustrates a SEM image of silver nanostructures synthesized with HEC at a concentration of 10 mg/mL, with NaCl and KBr concentrations at 4 mM, in accordance with various aspects.

FIG. 3C illustrates a SEM image of silver nanostructures synthesized with HEC at a concentration of 20 mg/mL, with NaCl and KBr concentrations at 4 mM, in accordance with various aspects.

FIG. 3D illustrates a SEM image of silver nanostructures synthesized with HEC at a concentration of 40 mg/mL, with NaCl and KBr concentrations at 4 mM, in accordance with various aspects.

FIG. 4A illustrates a SEM image of silver nanostructures synthesized with NaCl and KBr at a concentration of 0.4 mM, with HEC concentration at 20 mg/mL, in accordance with various aspects.

FIG. 4B illustrates a SEM image of silver nanostructures synthesized with NaCl and KBr at a concentration of 0.8 mM, with HEC concentration at 20 mg/mL, in accordance with various aspects.

FIG. 4C illustrates a SEM image of silver nanostructures synthesized with NaCl and KBr at a concentration of 2 mM, with HEC concentration at 20 mg/mL, in accordance with various aspects.

FIG. 4D illustrates a SEM image of silver nanostructures synthesized with NaCl and KBr at a concentration of 4 mM, with HEC concentration at 20 mg/mL, in accordance with various aspects.

FIG. 5A illustrates a SEM image of silver nanostructure synthesized using an NaCl:KBr molar ratio of 3:1, with HEC concentration at 20 mg/mL and with a total concentration of NaCl and KBr of 8 mM, in accordance with various aspects.

FIG. 5B illustrates a SEM image of silver nanostructure synthesized using an NaCl:KBr molar ratio of 2:1, with HEC concentration at 20 mg/mL and with a total concentration of NaCl and KBr of 8 mM, in accordance with various aspects.

FIG. 5C illustrates a SEM image of silver nanostructure synthesized using an NaCl:KBr molar ratio of 1:1, with HEC concentration at 20 mg/mL and with a total concentration of NaCl and KBr of 8 mM, in accordance with various aspects.

FIG. 5D illustrates a SEM image of silver nanostructure synthesized using an NaCl:KBr molar ratio of 1:3, with HEC concentration at 20 mg/mL and with a total concentration of NaCl and KBr of 8 mM, in accordance with various aspects.

FIG. 5E illustrates a phase diagram for silver nanostructures at various bromide and chloride concentrations, in accordance with various aspects.

FIG. 6 illustrates X-ray diffraction patterns of synthesized silver nanowires and bipyramids, in accordance with various aspects.

FIG. 7A illustrates a low magnification SEM image of silver nanowires synthesized with HEC under nitrogen purging, in accordance with various aspects.

FIG. 7B illustrates a high magnification SEM image of silver nanowires synthesized with HEC under nitrogen purging, in accordance with various aspects.

FIG. 8A illustrates a SEM image of silver nanowires synthesized with HEC having a molecular weight of 380,000, in accordance with various aspects.

FIG. 8B illustrates a SEM image of silver nanowires synthesized with HEC having a molecular weight of 720,000, in accordance with various aspects.

FIG. 8C illustrates a SEM image of silver nanowires synthesized using butanediol as the reaction solvent, in accordance with various aspects.

FIG. 8D illustrates a SEM image of silver nanowires synthesized using a solvent mixture of 50 wt % ethylene glycol and 50 wt % glycerol as the reaction solvent, in accordance with various aspects.

FIG. 9A illustrates a UV-visible spectrum of thin film on a glass slide formed by drop-casting a solution of silver nanowires, in accordance with various aspects.

FIG. 9B illustrates a SEM cross-sectional image of the thin film on a glass slide shown in FIG. 9A, in accordance with various aspects.

FIG. 10A illustrates the chemical structure of hydroxyethyl cellulose (HEC).

FIG. 10B illustrates a SEM image of silver nanowires prepared using HEC and using a concentration of NaCl of 4 mM and a concentration of KBr of 4 mM, in accordance with various aspects.

FIG. 10C illustrates a SEM image of silver bipyramids prepared using HEC and using a concentration of NaCl of 3.2 mM and a concentration of KBr of 1.6 mM, in accordance with various aspects.

FIG. 10D illustrates a SEM image of faceted silver nanoparticles prepared using HEC and using a concentration of NaCl of 0.8 mM, in accordance with various aspects.

FIG. 10E illustrates the chemical structure of hydroxypropyl cellulose (HPC).

FIG. 10F illustrates a SEM image of silver nanowires prepared using HPC and using a concentration of NaCl of 0.8 mM and a concentration of KBr of 0.8 mM, in accordance with various aspects.

FIG. 10G illustrates a SEM image of silver bipyramids prepared using HPC and using a concentration of NaCl of 4 mM and a concentration of KBr of 2 mM, in accordance with various aspects.

FIG. 10H illustrates a SEM image of silver nanocubes prepared using HPC and using a concentration of NaCl of 1 mM, in accordance with various aspects.

FIG. 10I illustrates the chemical structure of hydroxypropyl methylcellulose (HPMC).

FIG. 10J illustrates a SEM image of silver nanowires prepared using HPMC and using a concentration of NaCl of 2 mM and a concentration of KBr of 2 mM, in accordance with various aspects.

FIG. 10K illustrates the chemical structure of hydroxyethyl methylcellulose (HEMC).

FIG. 10L illustrates a SEM image of silver nanowires prepared using HEMC and using a concentration of NaCl of 4 mM and a concentration of KBr of 4 mM, in accordance with various aspects.

FIG. 11A illustrates a SEM image of silver nanowires prepared using PVP, in accordance with various aspects.

FIG. 11B illustrates a SEM image of silver nanowires prepared using HEC having a length of about 50 microns, in accordance with various aspects.

FIG. 11C illustrates a SEM image of silver nanowires prepared using HEC having a length of greater than 100 microns, in accordance with various aspects.

FIG. 11D illustrates a plot of specular transmittance (2=550 nm) versus sheet resistance for films made from silver nanowires made using PVP, short silver nanowires made using HEC, and long silver nanowires made using HEC, in accordance with various aspects.

FIG. 12 illustrates a plot of specular transmittance (2=550 nm) vs sheet resistance for films made from short silver nanowires made using HEC, long silver nanowires made using HEC, and two commercial Ag nanowires, in accordance with various aspects.

FIG. 13 illustrates UV-vis spectra of various silver nanostructures, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

As used herein, the term “polymer” refers to a molecule having at least one repeating unit and can include copolymers.

### Silver Nanomaterial.

Various aspects of the present invention provide a silver nanomaterial that is stabilized with cellulose or a cellulose derivative. The silver nanomaterial can be silver nanowires, or a particulate silver nanomaterial such as silver bipyramids, silver nanocubes, or faceted silver nanoparticles. In various aspects, the particulate silver nanomaterial includes a combination of silver bipyramids, silver nanocubes, or faceted silver nanoparticles. In various aspects, the particulate silver nanomaterial is substantially composed of one of silver bipyramids, silver nanocubes, or faceted nanoparticles, with the other particle species forming 0 wt % to 5 wt % of the particulate silver nanomaterial, or 0 wt % to 3 wt %, or 0 wt % to 1 wt %, or 0 wt % to 0.1 wt %, or 0 wt % of the particulate silver nanomaterial. In various aspects, the silver nanomaterial is substantially composed of silver nanowires, with other species of silver nanomaterial forming 0 wt % to 5 wt % of the silver nanomaterial, or 0 wt % to 3 wt %, or 0 wt % to 1 wt %, or 0 wt % to 0.1 wt %, or 0 wt % of the silver nanomaterial.

The silver nanowires can have a diameter of 20 nm to 500 nm, or a diameter of 100 nm to 500 nm, or less than or equal to 500 nm and greater than or equal to 20 nm and less than, equal to, or greater than 30 nm, 40, 50, 60, 70, 80, 90, 100, 110, 120, 130, 140, 150, 160, 170, 180, 190, 200, 210, 220, 240, 260, 280, 300, 320, 340, 360, 380, 400, 420, 440, 460, or 480 nm (e.g., D50 [num], D90 [num], D99 [num], or D100 [num] diameter). The silver nanowires can have a length of at least 1 micron, such as at least 10 microns, 50, 100, 150, 200, 400, 600, 800, 1,000, 5,000, or at least 10,000 microns. The silver nanowires can have a length of 1 micron to 10,000 microns, or 50 microns to 500 microns, or less than or equal to 10,000 microns and greater than or equal to 1 micron and less than, equal to, or greater than 2 microns, 5, 10, 20, 40, 60, 80, 100, 120, 140, 160, 180, 200, 250, 300, 400, 500, 600, 800, 1,000, 1,250, 1,500, 1,700, 2,000, 5,000, or 9,000 microns (e.g., D50 [num], D90 [num], D99 [num], or D100 [num] length).

The particulate silver nanomaterial, such as silver bipyramids, silver nanocubes, or faceted silver nanoparticles, can have a largest dimension of 20 nm to 500 nm, or 100 nm to 200 nm, or less than or equal to 500 nm and greater than or equal to 20 nm and less than, equal to, or greater than 30 nm, 40, 50, 60, 70, 80, 90, 100, 110, 120, 130, 140, 150, 160, 170, 180, 190, 200, 210, 220, 240, 260, 280, 300, 320, 340, 360, 380, 400, 420, 440, 460, or 480 nm (e.g., D50 [num], D90 [num], D99 [num], or D100 [num] particle size). The term “D50,” as used herein refers to the 50th percentile number- or volume-based median particle or nanowire diameter, or nanowire length, below which 50% by number or volume of the population is found. Other percentages such as D10 (10%), D90 (90%), D99 and D100 (100%) are also commonly used. The term “D99,” as used herein, refers to the 99th percentile of either a number- or volume-based median particle or nanowire diameter, or nanowire length, below which 99% by number or volume of the population is found. The number or volume measurement is indicated by [num] for number or [vol] for volume. The particulate silver nanomaterial, such as silver bipyramids, silver nanocubes, or faceted silver nanoparticles, can have a D50 [num] particle diameter of less than about 300 nm (e.g., a D50 [num] particle diameter of about 150 nm to about 250 nm; about 175 to about 225 nm; or about 100 to about 200 μm). The particulate silver nanomaterial, such as silver bipyramids, silver nanocubes, or faceted silver nanoparticles, can have a D90 [num] particle diameter of less than about 400 nm (e.g., a D90 [num] particle diameter of about 100 μm to about 250 μm; about 125 μm to about 275 μm; or about 150 μm to about 300 μm). The particulate silver nanomaterial, such as silver bipyramids, silver nanocubes, or faceted silver nanoparticles can have a D99 [num] particle diameter of less than about 500 nm (e.g., D99 [num] particle diameter of about 20 nm nm to about 400 nm; about 50 nm to about 350 nm; or about 100 nm to about 300 nm). In other aspects, particulate silver nanomaterial, such as silver bipyramids, silver nanocubes, or faceted silver nanoparticles, can have a D100 [num] particle diameter of less than about 600 nm (e.g., a D100 [num] particle diameter of about 5 nm to about 500 nm, about 10 nm to about 450 nm; or about 15 nm to about 400 nm). Particle diameters and particle size distributions can be determined by single particle optical sizing (SPOS) as described, for example, in U.S. Pat. No. 9,423,335, which is incorporated by reference as if fully set forth herein. Other methods for determining particle sizes, nanowire diameters, nanowire lengths, and size distributions thereof can also be used, including SEM, microscopy, light scattering, laser diffraction, coulter counter (electrical zone sensing), and digital image analysis. In various aspects the particulate silver nanomaterial, such as silver bipyramids, silver nanocubes, or faceted silver nanoparticles, can have a relatively homogeneous size distribution, such that the particulate silver nanomaterial has a polydispersity index (PDS) of less than 0.2 and a size standard deviation of less than 30%.

Particle sizes, nanowire diameters, and nanowire lengths can be determined with or without the cellulose or cellulose derivative bound to the silver nanomaterial. The cellulose or cellulose derivative that stabilizes the silver nanomaterial can add 1 nm to 100 nm to the particle size, nanowire diameter, or nanowire length, such as less than or equal to 100 nm and greater than or equal to 1 nm and less than, equal to, or greater than 2 nm, 3, 4, 5, 6, 7, 8, 9, 10, 12, 14, 16, 18, 20, 25, 30, 35, 40, 45, 50, 60, 70, 80, or 90 nm.

The cellulose or cellulose derivative can at least partially coat the silver nanomaterial. In various aspects, at least some of the cellulose or cellulose is free and unbound to the silver nanowires or to the particulate silver nanomaterial such as silver bipyramids, silver nanocubes, or faceted silver nanoparticles. In other aspects, substantially all of the cellulose or cellulose derivative coats the silver nanomaterial. The cellulose or cellulose derivative can be a bio-derived agent. The cellulose or cellulose derivative can be bound to the silver nanomaterial, such as via electrostatic forces, ionic bonding, hydrogen bonding, covalent bonding, van der Waals forces, or a combination thereof. The cellulose or cellulose derivative can include-OH groups that can be bound to the silver nanomaterial. The cellulose or cellulose derivative can stabilize the silver nanomaterial by preventing or reducing their agglomeration (e.g., preventing or reducing contact between the nanomaterials during the formation thereof) and by preventing or reducing settling of the nanomaterial in solution. The reduction of the silver nanomaterial precursor and the stabilization of the resulting silver nanomaterial can be simultaneous.

The cellulose or cellulose derivative can be any suitable cellulose or cellulose derivative. For example, the cellulose or cellulose derivative can be hydroxymethyl cellulose, hydroxymethyl methylcellulose, hydroxyethyl cellulose (HEC), hydroxyethyl methylcellulose (HEMC), hydroxypropyl cellulose (HPC), hydroxypropyl methylcellulose (HPMC), sodium carboxymethyl cellulose (CMC) or methyl 2-hydroxyethyl cellulose (MHEC), or a combination thereof. The cellulose or cellulose derivative can be hydroxyethyl cellulose (HEC). The cellulose or cellulose derivative can have any suitable molecular weight. For example, the cellulose or cellulose derivative can have a weight-average molecular weight (Mw) of 10,000 to 2,000,000, 80,000 to 1,500,000, or less than or equal to 2,000,000 and greater than or equal to 10,000 and less than, equal to, or greater than 20,000, 40,000, 60,000, 80,000, 90,000, 100,000, 120,000, 150,000, 200,000, 500,000, 750,000, 1,000,000, 1,300,000, 1,600,000, or 1,900,000.

The cellulose or cellulose derivative acts as a reducing agent for the synthesis of the silver nanomaterial from a silver nanomaterial precursor. The cellulose or cellulose derivative can also act as a capping agent, rheology modifier (e.g., viscosifier), and stabilizer for the silver nanomaterial. The cellulose or cellulose derivative can reduce the silver nanomaterial precursor to form the silver nanomaterial either as the sole reducing agent or in the presence of one or more second reducing agents. The silver nanomaterial precursor can be any suitable precursor that can be reduced to form the silver nanomaterial. The silver nanomaterial precursor can include silver in an oxidized state. The silver nanomaterial precursor can include silver nitrate, silver acetate, silver citrate, silver formate, silver carbonate, silver fluoride, silver nitrite, silver chloride, silver bromide, silver iodide, silver phosphate, silver oxide, silver hydroxide, silver acetate hydrate, or a combination thereof. The silver nanomaterial precursor can include silver nitrate. The silver nanomaterial can include unreacted silver nanomaterial precursor, or the silver nanomaterial can be substantially free of the silver nanomaterial precursor (e.g., the silver nanomaterial precursor can be completely consumed during the reduction thereof, or the silver nanomaterial precursor can be removed during purification of the silver nanomaterial).

The second reducing agent can be any suitable reducing agent that can reduce the silver nanomaterial precursor to the silver nanomaterial in the presence of the cellulose or cellulose derivative. The second reducing agent can include ascorbic acid, sodium borohydride, hydrazine, or a combination thereof. In various aspects, the silver nanomaterial includes the second reducing agent. In other aspects, any second reducing agent used in the synthesis of the stabilized silver nanomaterial is removed during purification of the nanomaterial (e.g., via filtration from the reaction solution, and/or via other purification techniques).

The silver nanomaterial can further include one or more halides. For example, the silver nanomaterial can include chloride ions, bromide ions, fluorine ions, iodine ions, or a combination thereof. The silver nanomaterial can include chloride ions, or bromide ions, or a combination of chloride ions and bromide ions. The source of the one or more halide ions can be any suitable source, such as a halide salt, such as an ammonium halide, a sodium halide, a potassium halide, a calcium halide, an aluminum halide, or a combination thereof. The one or more halides can be a remnant of a reaction solution used to form the silver nanomaterial. In some aspects, the one or more halides can be washed from the silver nanomaterial after synthesis such that the silver nanomaterial is substantially free of the halides. In other aspects, the silver nanomaterial includes the one or more halides, such as in a coating thereon, as a homogeneous distribution in the bulk thereof, or a combination thereof.

The silver nanomaterial can have a molar ratio of chloride ions to bromide ions of 100:1 to 1:100, or 10:1 to 1:10, or 3:1 to 1:3, or less than or equal to 100:1 and greater than or equal to 1:100 and less than, equal to, or greater than 1:90, 1:80, 1:70, 1:60, 1:50, 1:40, 1:30, 1:20, 1:18, 1:16, 1:14, 1:12, 1:10, 1:8, 1:6, 1:5, 1:4, 1:3, 1:2.5, 1:2, 1:1, 1:1.5, 1:1, 1.5:1, 2:1, 2.5:1, 3:1, 6:1, 8:1, 10:1, 12:1, 14:1, 16:1, 18:1, 20:1, 30:1, 40:1, 50:1, 60:1, 70:1, 80:1, or 90:1.

Various aspects of the present invention provide a silver nanomaterial stabilized with cellulose or a cellulose derivative, the silver nanomaterial including chloride ions and bromide ions having a chloride:bromide molar ratio of 100:1 to 1:100, or 10:1 to 1:10, or 3:1 to 1:3, or less than or equal to 100:1 and greater than or equal to 1:100 and less than, equal to, or greater than 1:90, 1:80, 1:70, 1:60, 1:50, 1:40, 1:30, 1:20, 1:18, 1:16, 1:14, 1:12, 1:10, 1:8, 1:6, 1:5, 1:4, 1:3, 1:2.5, 1:2, 1:1, 1:1.5, 1:1, 1.5:1, 2:1, 2.5:1, 3:1, 6:1, 8:1, 10:1, 12:1, 14:1, 16:1, 18:1, 20:1, 30:1, 40:1, 50:1, 60:1, 70:1, 80:1, or 90:1.

Various aspects of the present invention provide a silver nanomaterial including silver nanowires stabilized with hydroxyethyl cellulose. The silver nanowires can include chloride ions and bromide ions in a molar ratio of 2:1 or less. The nanowires can have a length of at least 1 micron and a diameter of 20 nm to 500 nm.

Various aspects of the present invention provide a silver nanomaterial including a particulate silver nanomaterial such as silver bipyramids, silver nanocubes, or faceted silver nanoparticles, stabilized with cellulose or a cellulose derivative, the silver nanowires including chloride ions and bromide ions in a molar ratio of 3:1 to 1:1. The particulate silver nanomaterial can have a largest dimension of 20 nm to 500 nm.

Various aspects of the present invention provide a silver nanomaterial that includes a reaction product of a composition that includes a silver precursor, cellulose or a cellulose derivative, and halide ions.

Various aspects of the present invention provide a silver nanomaterial including a reaction product of a composition that includes silver nitrate, hydroxyethyl cellulose, a bromide salt, and a chloride salt. The silver nanomaterial can include a silver nanowire, or a particulate silver nanomaterial such as a silver bipyramid, silver nanocube, or a faceted silver nanoparticle.

Conductive film.

Various aspects of the present invention provide an electrically conductive film that includes the silver nanomaterial described herein. For example, as measured by a four-point probe, the film can have a sheet resistance of 0.1 Ωsq⁻¹ to 50 Ωsq⁻¹, 1 Ωsq⁻¹ to 10 Ωsq⁻¹, or less than or equal to 50 Ωsq⁻¹ and greater than or equal to 0.1 Ωsq⁻¹ and less than, equal to, or greater than 0.2 Ωsq⁻¹, 0.4, 0.6, 0.8, 1, 1.5, 2, 2.5, 3, 3.5, 4, 4.5, 5, 6, 7, 8, 9, 10, 15, 20, 25, 30, 35, 40, or 45 Ωsq⁻¹. The conductive film can have any suitable thickness, such as a thickness of 50 nm to 1,000 microns, or less than or equal to 1,000 microns and greater than or equal to 50 nm and less than, equal to, or greater than 100 nm, 200, 300, 400, 500, 600, 700, 800, 900 nm, 1 micron, 1.5, 2, 2.5, 3, 4, 5, 6, 8, 10, 15, 20, 25, 50, 75, 100, 150, 200, 250, 500, or 750 microns. In various aspects, the thickness of the conductive film can be controlled by adjusting the amount of materials deposited on the substrate during the formation of the film, which can allowing tuning of the transmittance and/or sheet resistance of the film.

The electrically conductive film can be optically transparent. For example, the electrically conductive film can have a transmittance at 550 nm as determined by UV-visible spectroscopy of 50% to 100%, or 70% to 90%, or less than or equal to 100% and greater than or equal to 50% and less than, equal to, or greater than 55, 60, 65, 70, 72, 74, 76, 78, 80, 82, 84, 86, 88, 90, 92, 94, 96, 97, 98, or 99%.

Various aspects of the present invention provide a method of forming an electrically conductive film. The electrically conductive film can be an optically transparent film. The method can include forming a conductive film that includes the silver nanomaterial described herein, such as a silver nanowire, or a particular silver nanomaterial such as a silver bipyramid, silver nanocube, or a faceted silver nanoparticle. The conductive film can be formed from the silver nanomaterial in any suitable way. For example, the method can include drop-casting a solution including the silver nanomaterial on a substrate to form the conductive film on the substrate. The solution can include a solvent such as an organic solvent, an aqueous solvent, water, or a combination thereof. The organic solvent can include ethylene glycol, N-methylpyrrolidone, dimethyl sulfoxide, an alcohol, or a combination thereof. The alcohol can include ethanol, isopropanol, butanol, or a combination thereof. In various aspects, the substrate is a glass substrate. The temperature used for the drop-casting of the solution including the silver nanomaterial on the substrate can be any suitable temperature, such as a temperature of 50° C. to 200° C., or 75° C. to 150° C., or less than or equal to 200° C. and greater than or equal to 50° C. and less than, equal to, or greater than 60° C., 70, 80, 90, 100, 110, 120, 130, 140, 150, 160, 170, 180, or 190° C.

### Method of Making a Silver Nanomaterial.

Various aspects of the present invention provide a method of forming a silver nanomaterial. The method can be any suitable method that forms the silver nanomaterial of the present invention. The method can include forming a reaction solution including cellulose or a cellulose derivative, and further including a silver nanomaterial precursor, to form the silver nanomaterial.

The silver nanomaterial precursor can include silver nitrate, silver acetate, silver citrate, silver formate, silver carbonate, silver fluoride, silver nitrite, silver chloride, silver bromide, silver iodide, silver phosphate, silver oxide, silver hydroxide, silver acetate hydrate, or a combination thereof. The silver nanomaterial precursor can include silver nitrate. The silver nanomaterial precursor can have any suitable concentration in the reaction solution, such as a concentration of 0.01 mg/mL to 200 mg/mL, 1 mg/mL to 30 mg/mL, or 1 mg/mL to 5 mg/mL, or less than or equal to 200 mg and greater than or equal to 0.01 mg/mL and less than, equal to, or greater than 0.05 mg/mL, 0.1, 0.2, 0.4, 0.6, 0.8, 1, 1.5, 2, 2.5, 3, 3.5, 4, 4.5, 5, 6, 7, 8, 9, 10, 15, 20, 30, 40, 50, 75, 100, 125, 150, 175, or 190 mg/mL.

The cellulose or cellulose derivative can be hydroxymethyl cellulose, hydroxymethyl methylcellulose, hydroxyethyl cellulose, hydroxyethyl methylcellulose, hydroxypropyl cellulose, hydroxypropyl methylcellulose, sodium carboxymethyl cellulose (CMC) or methyl 2-hydroxyethyl cellulose (MHEC), or a combination thereof. The cellulose or cellulose derivative can be hydroxyethyl cellulose (HEC). The cellulose or cellulose derivative can have any suitable molecular weight. For example, the cellulose or cellulose derivative can have a weight-average molecular weight (Mw) of 10,000 to 2,000,000, or 80,000 to 1,500,000. The reaction solution can have any suitable concentration of the cellulose or cellulose derivative, such as a concentration of 0.01 mg/mL to 200 mg/mL, 1 mg/mL to 30 mg/mL, or less than or equal to 200 mg/mL and greater than or equal to 0.01 mg/mL and less than, equal to, or greater than 0.05 mg/mL, 0.1, 0.2, 0.4, 0.6, 0.8, 1, 1.5, 2, 2.5, 3, 3.5, 4, 4.5, 5, 6, 7, 8, 9, 10, 15, 20, 30, 40, 50, 75, 100, 125, 150, 175, or 190 mg/mL. The reaction solution can have any suitable mass ratio of the silver nanomaterial precursor to the cellulose or cellulose derivative, such as 0.01:1 to 100:1, or 0.05:1 to 0.5:1, or less than or equal to 100:1 and greater than or equal to 0.01:1 and less than, equal to, or greater than 0.05:1, 0.1:1, 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.5:1, 3:1, 3.5:1, 4:1, 4.5:1, 5:1, 6:1, 7:1, 8:1, 9:1, 10:1, 15:1, 20:1, 25:1, 30:1, 40:1, 50:1, 60:1, 70:1, 80:1, or 90:1.

The reaction solution can be substantially free of polyvinylpyrrolidone (PVP). For example, PVP can be equal to or less than 5 wt %, 4, 3, 2, 1, 0.1, 0.01, or 0.001 wt % of the reaction solution.

The method can include heating the reaction solution to form the silver nanomaterial. The heating can include heating to a temperature of 50° C. to 250° C., or 110° C. to 140° C., or less than or equal to 250° C. and greater than or equal to 50° C. and less than, equal to, or greater than 60, 70, 80, 90, 100, 102, 104, 106, 108, 110, 112, 114, 116, 118, 120, 121, 122, 123, 124, 125, 126, 127, 128, 129, 130, 132, 134, 136, 138, 140, 150, 160, 170, 180, 190, 200, 210, 220, 230, or 240° C. The heating can be performed for any suitable duration, such as a duration of 1 min to 24 h, or 1 h to 8 h, or less than or equal to 24 h and greater than or equal to 1 min and less than, equal to, or greater than 2 min, 3, 4, 5, 6, 8, 10, 15, 20, 25, 30, 35, 40, 45, 50, 55 min, 1 h, 1.5, 2, 2.5, 3, 4, 5, 6, 8, 10, 12, 14, 16, 18, 20, or 22 h. The heating can be performed under ambient pressure, or elevated pressure.

The method can include agitating the solution. In various aspects, the method is free of agitating the solution. In various aspects, the method can include agitating the solution until components thereof have fully dissolved, and then allowing the reaction solution to sit undisturbed throughout the entire heating period or the remainder of the heating period.

The reaction solution can further include a second reducing agent. The second reducing agent can be any suitable reducing agent that can reduce the silver nanomaterial precursor to the silver nanomaterial in the presence of the cellulose or cellulose derivative. The second reducing agent can include ascorbic acid, sodium borohydride, hydrazine, or a combination thereof.

The reaction solution can further include a base. The base can be any suitable base, such as a water-soluble hydroxide salt. The base can be potassium hydroxide, sodium hydroxide, ammonium hydroxide, lithium hydroxide, or a combination thereof. In various aspects, using base, or using a greater amount of base, in the reaction solution can result in the formation of smaller silver nanomaterial dimensions. The base can have any suitable concentration in the reaction solution, such as a concentration of 0 M (e.g., the reaction solution can be substantially free of base), or 0.1 M to 10 M, or 0.3 M to 1 M, or less than or equal to 10 M and greater than or equal to 0.1 M and less than, equal to, or greater than 0.2 M, 0.3, 0.4, 0.5, 0.6, 0.7, 0.8, 0.9, 1, 1.2, 1.4, 1.6, 1.8, 2, 2.5, 3, 4, 5, 6, 7, 8, or 9 M.

The reaction solution can further include one or more solvents. The reaction solvent can include any suitable solvent, such as dimethyl sulfoxide (DMSO), water, ethylene glycol, butanediol, glycerol, diethylene glycol, triethylene glycol monomethyl ether (TGME), ethanol, acetone, butyl glycol acetate, carbitol acetate, glycol ether, ethyl glycol, dimethyl esters of adipic, glutaric, or succinic acids, or a combination thereof. The solvent can include or be ethylene glycol. In various aspects, the solvent can have a boiling point of 100° C. or higher.

The reaction solution can further include one or more halide salts. The reaction solution can include a bromide salt, an iodide salt, a chloride salt, a fluoride salt, or a combination thereof. The halide salt can include an ammonium halide, a sodium halide, a potassium halide, a calcium halide, an aluminum halide, or a combination thereof. The reaction solution can include a bromide salt, a chloride salt, or a combination of a bromide salt and a chloride salt. The reaction solution can include ammonium bromide, sodium bromide, potassium bromide, calcium bromide, aluminum bromide, ammonium chloride, sodium chloride, potassium chloride, calcium chloride, aluminum chloride, or a combination thereof. The reaction solution can include KBr, NaCl, or a combination of KBr and NaCl. The reaction solution can have any suitable molar ratio of chloride ions to bromide ions, such as 100:1 to 1:100, or 10:1 to 1:10, or 3:1 to 1:3, or less than or equal to 100:1 and greater than or equal to 1:100 and less than, equal to, or greater than 1:90, 1:80, 1:70, 1:60, 1:50, 1:40, 1:30, 1:20, 1:18, 1:16, 1:14, 1:12, 1:10, 1:8, 1:6, 1:5, 1:4, 1:3, 1:2.5, 1:2, 1:1, 1:1.5, 1:1, 1.5:1, 2:1, 2.5:1, 3:1, 6:1, 8:1, 10:1, 12:1, 14:1, 16:1, 18:1, 20:1, 30:1, 40:1, 50:1, 60:1, 70:1, 80:1, or 90:1. The reaction solution can have any suitable total concentration of the one or more halide salts, such as 0.1 to 20 mM, or 0.1 mM to 10 mM, or 1 mM to 1 mM, or less than or equal to 10 mM and greater than or equal to 0.1 mM and less than, equal to, or greater than 0.2 mM, 0.3, 0.4, 0.5, 0.6, 0.7, 0.8, 0.9, 1, 1.2, 1.4, 1.6, 1.8, 2, 2.5, 3, 4, 5, 6, 7, 8, 9, 10, 12, 14, 16, or 18 mM.

The method can further include separating and/or purifying the silver nanomaterial from the reaction solution and other materials therein. The separation can include filtration, decantation, washing, one or more other purification techniques, or a combination thereof.

In various aspects, the method of making the silver nanomaterial can include heating a reaction solution including a solvent, hydroxyethyl cellulose, silver nitrate, a bromide salt, and a chloride salt and a silver nanomaterial precursor to a temperature of 110° C. to 140° C. to form the silver nanomaterial, wherein the reaction solution has a ratio of chloride ions to bromide ions of 3:1 to 1:3. The silver nanomaterial can includes a silver nanowire having a length of at least 1 micron and a diameter of 20 nm to 500 nm or a particulate silver nanomaterial such as a silver bipyramid, a silver nanocube, or a faceted silver nanoparticle having a largest dimension of 20 nm to 500 nm.

In various aspects, the present invention provides a silver nanomaterial formed by any of the methods described herein. In various aspects, the present invention provides a silver nanomaterial including a reaction product of a reaction solution that includes silver nitrate, a solvent (e.g., ethylene glycol), hydroxyethyl cellulose, a bromide salt, and a chloride salt, wherein the reaction solution has a ratio of chloride ions to bromide ions of 3:1 to 1:3.

In various aspects, the silver nanomaterial formed by the method is substantially composed of silver nanowires, with other species of silver nanomaterial forming 0 wt % to 5 wt % of the silver nanomaterial, or 0 wt % to 3 wt %, or 0 wt % to 1 wt %, or 0 wt % to 0.1 wt %, or 0 wt % of the silver nanomaterial. In various aspects, the silver nanomaterial formed by the method is substantially a particulate silver nanomaterial, with nanowires forming p0 wt % to 5 wt % of the silver nanomaterial, or 0 wt % to 3 wt %, or 0 wt % to 1 wt %, or 0 wt % to 0.1 wt %, or 0 wt % of the silver nanomaterial. In various aspects, the silver nanomaterial formed by the method is a particulate silver nanomaterial that is substantially composed of one of silver bipyramids, silver nanocubes, or faceted nanoparticles, with the other particle species or nanowires forming 0 wt % to 5 wt % of the particulate silver nanomaterial, or 0 wt % to 3 wt %, or 0 wt % to 1 wt %, or 0 wt % to 0.1 wt %, or 0 wt % of the particulate silver nanomaterial.

### EXAMPLES

Various aspects of the present invention can be better understood by reference to the following Examples which are offered by way of illustration. The present invention is not limited to the Examples given herein.

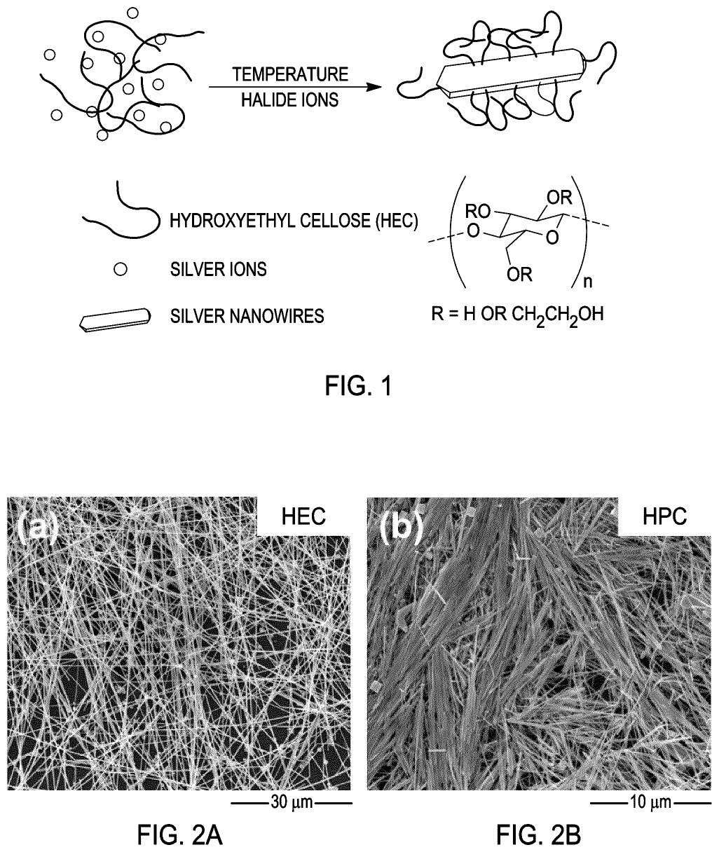

The present invention is not limited to any particular theory of operation. The synthesis of silver nanostructures in the Examples herein includes a colloidal chemical reduction of a silver nanomaterial precursor in the presence of hydroxyethyl cellulose (HEC). The HEC acts as a reducing agent and a stabilizer. FIG. 1 illustrates a schematic diagram of silver nanowire synthesis with HEC. The hydroxyl group on the HEC can provide the reducing ability for the silver reduction. HEC possesses strong binding affinity towards silver nuclei surface, which is beneficial for nanocrystal stabilization and facilitating preferential growth. The network structure of HEC can also prevent aggregation of nanomaterials.

### Example 1. Synthesis of Silver Nanowires

In a typical synthesis of silver nanowires, 100 mg of 2-hydroxyethyl cellulose (HEC, Mv=90000 g/mol) was mixed with 2.5 mL of ethylene glycol (20 mg/mL HEC) in a 20 ml scintillation vial. The solution was stirred at 125° C. in a heating block until the 2-hydroxyethyl cellulose was completely dissolved. Then 0.05 ml of NaCl solution (0.4 mmol in 1 mL of ethylene glycol) was added into the above solution. Then 0.05 ml of KBr solution (0.4 mmol in 1 mL of ethylene glycol) was added into the above solution. Then 2.5 ml of AgNO₃ solution (70 mg/mL in ethylene glycol) was added into the above solution. After AgNO₃ solution was added, the mixture was kept undisturbed for 4 hours. Then the mixture was cooled and transferred into a centrifuge tube for further purification. The resulting Ag nanowires were collected by centrifugation and washed twice with deionized water. After purification, Ag nanowires were finally suspended in deionized water. Silver nanowires formed using the general procedure are shown in FIG. 2A.

The procedure was then repeated but using hydroxypropyl cellulose (HPC) in place of HEC, using a concentration of 40 mg/mL HPC. The silver nanowires formed are shown in FIG. 2B.

### Example 2. Variation of HEC Concentration

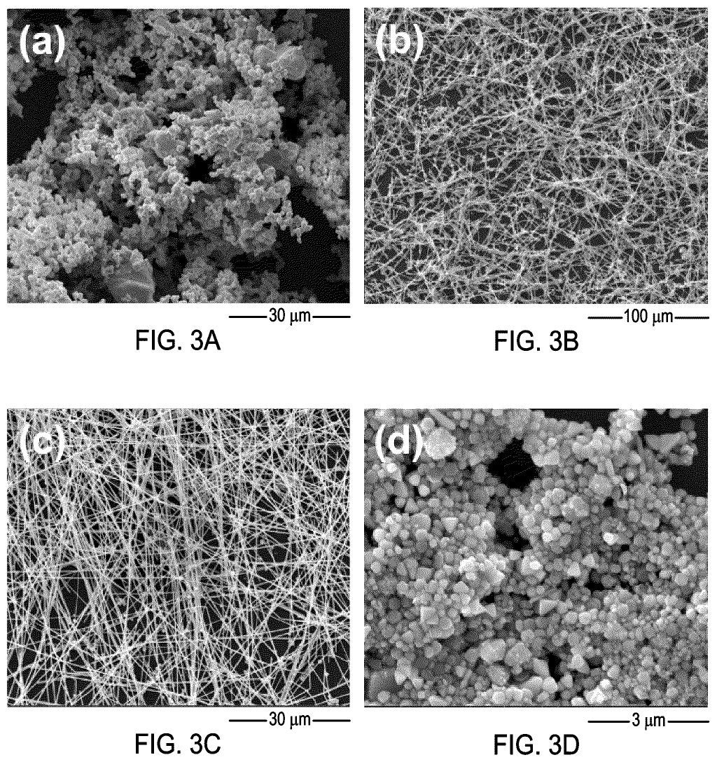

FIGS. 3A-3D illustrate SEM images of silver nanostructures synthesized with HEC at a concentration of 0 mg/mL, 10, 20, and 40 mg/mL, respectively, with NaCl and KBr concentrations at 4 mM. As shown in FIG. 3A, the absence of HEC yielded irregular shaped silver particles. As the HEC concentration was increased to 10 and 20 mg/ml, nanowires formed while faceted particles were obtained at higher HEC concentration (FIGS. 3B-D).

### Example 3. Variation of Halide Ion Concentration and Ratio

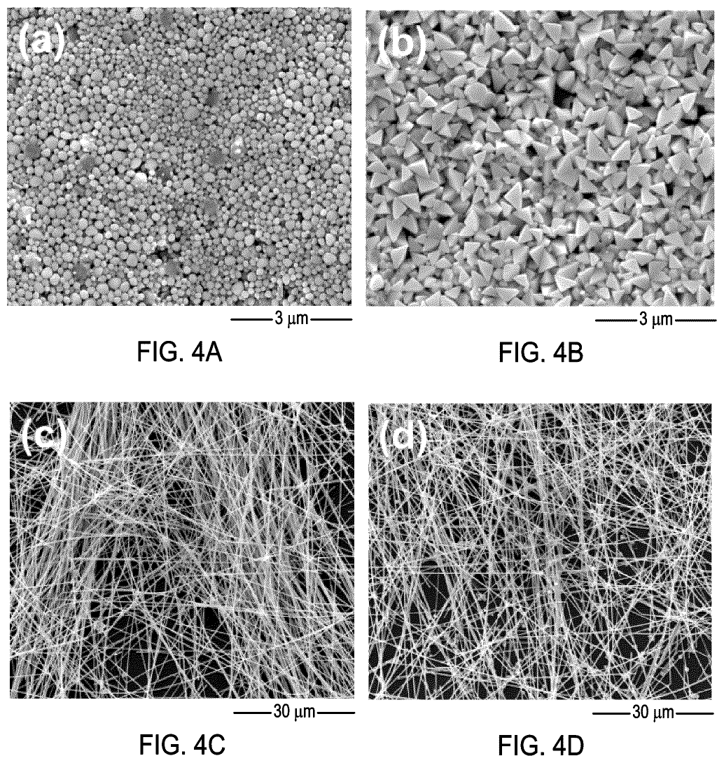

FIGS. 4A-4B illustrate SEM images of silver nanostructures synthesized with NaCl and KBr at a concentration of 0.4 mM, 0.8 mM, 2 mM, and 4 mM, respectively, with HEC concentration at 20 mg/mL. When the concentrations of NaCl and KBr were both kept at 0.4 M, small silver nanocrystals were synthesized (FIG. 4A). As their concentrations increased to 0.8 mM, silver bipyramids appeared in the product (FIG. 4B). Silver nanowires were obtained when the concentrations of NaCl and KBr were further adjusted to 2 mM and 4 mM, respectively (FIGS. 4C-D).

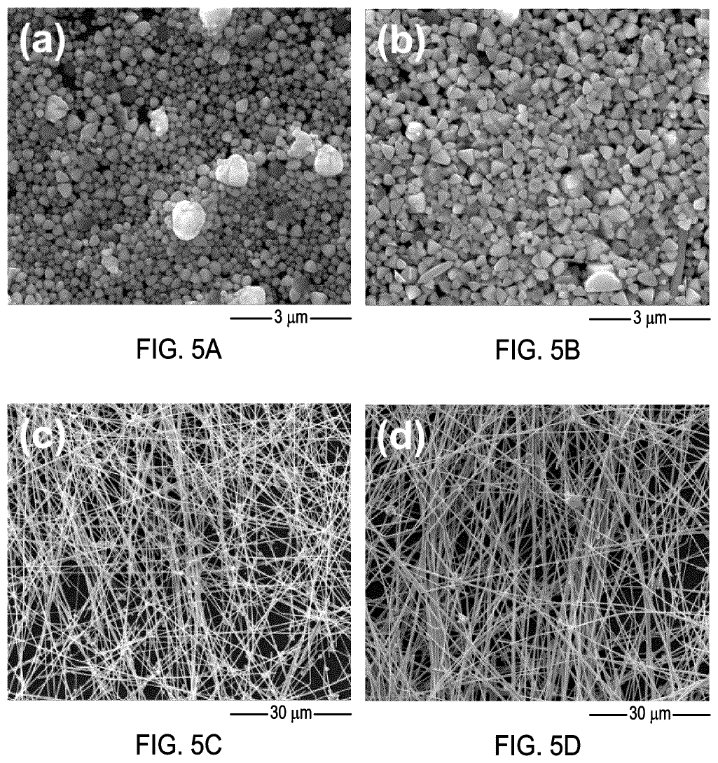

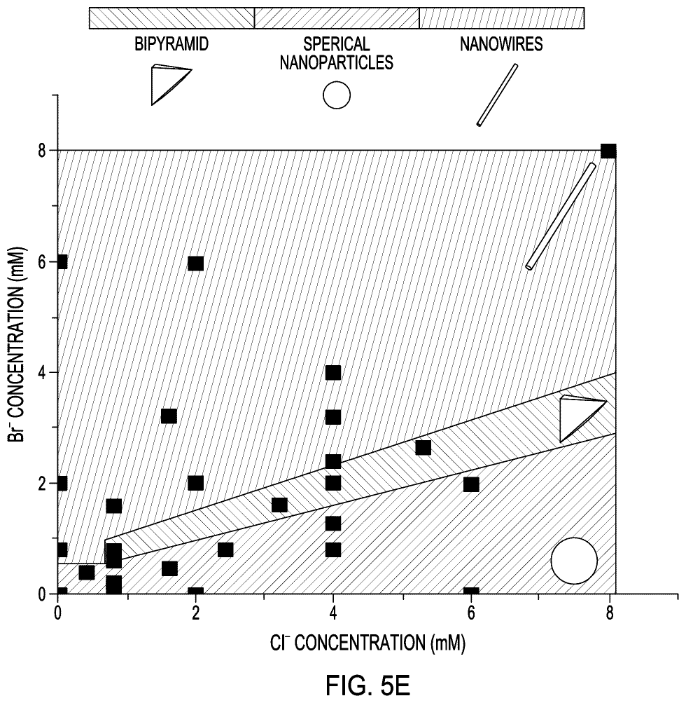

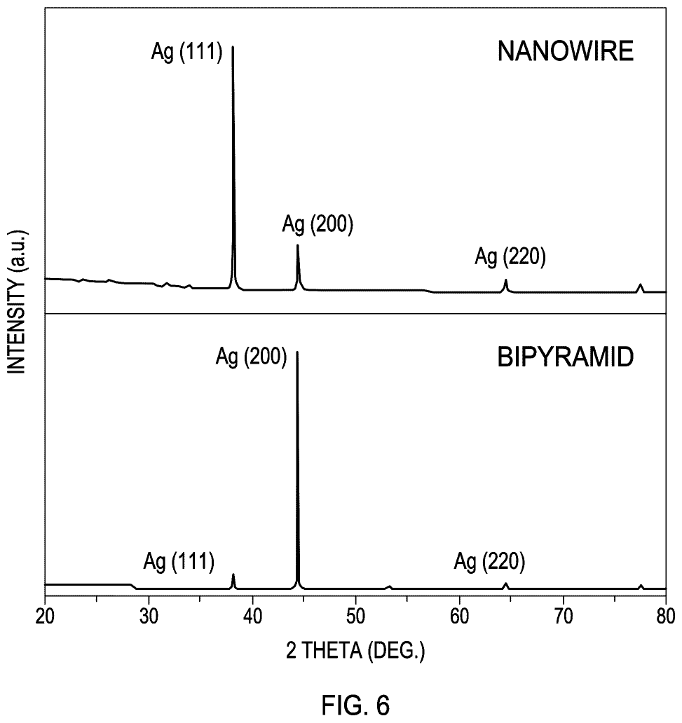

FIGS. 5A-5D illustrate SEM images of silver nanostructure synthesized using an NaCl:KBr molar ratio of 3:1, 2:1, 1:1, and 1:3, respectively, with HEC concentration at 20 mg/mL and with a total concentration of NaCl and KBr kept at 8 mM. As shown in FIG. 5A, faceted silver nanocrystals with small sizes were synthesized when the NaCl/KBr ratio was 3/1. Bipyramids appeared as the main product when the ratio was reduced to 2/1 (FIG. 5B). The standard synthesis of silver nanowires used the same concentration of NaCl and KBr (ratio is 1, FIG. 5C). Silver nanowires were still obtained when the ratio was reduced to 1/3 (FIG. 5D). Additionally, other NaCl and KBr concentrations were also studied, and the resulting silver nanostructures are summarized in the phase diagram shown in FIG. 5E. Silver nanowires and bipyramids exposed distinct facets as confirmed by XRD analysis (FIG. 6). Both silver nanowires and bipyramids showed XRD patterns which correspond to bulk silver. However, silver nanowires exposed {111}, {100}, and {110} facets, while silver bipyramids predominately exposed {100} facets.

### Example 4. Dimensional Control

The dimensions of silver nanostructures were controllable with variation of the synthesis parameters. Typically, silver nanowires synthesized in the presence of HEC had a length of over 100 μm and a diameter of about 200 nm, with an aspect ratio of over 500. The bipyramids typically had an edge length of about 400 nm. Compared to conventional nanowires synthesized in the presence of PVP by a similar polyol approach, the nanowires of the present Examples were much longer. Replacing HEC with HPC yielded smaller nanowires. The length of nanowires decreased to about 20 μm while the diameter was similar.

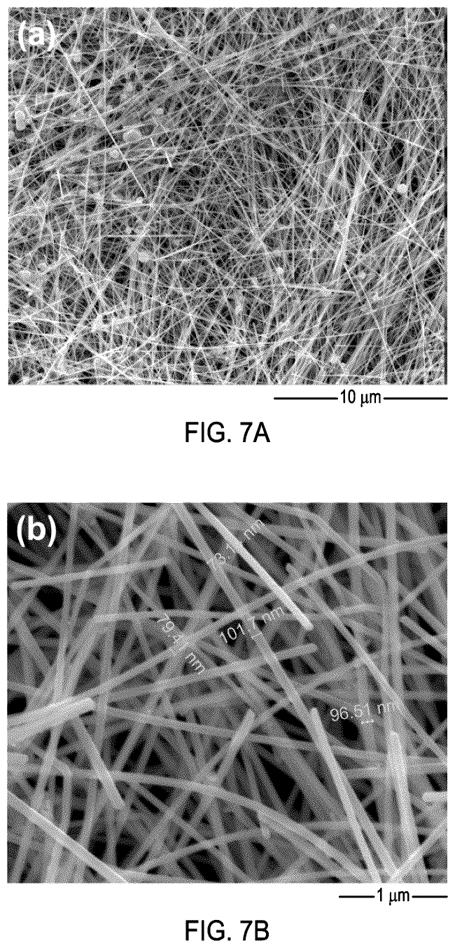

The reaction environment was controlled to tailor the dimensions of silver nanowires. Silver nanowires were formed from a reaction containing 20 mg/ml of HEC and 4 mM of KBr, with purging of the reaction with N2, which resulted in thinner and shorter nanowires. As shown in low and high magnification SEM images shown in FIGS. 7A-B, the length of nanowires decreased to about 50 μm and their diameter was reduced to about 100 nm. The result likely indicates that the nanowire growth was slightly hindered by removing the oxygen from the reaction.

### Example 5. Compatibility with Various Types of HEC

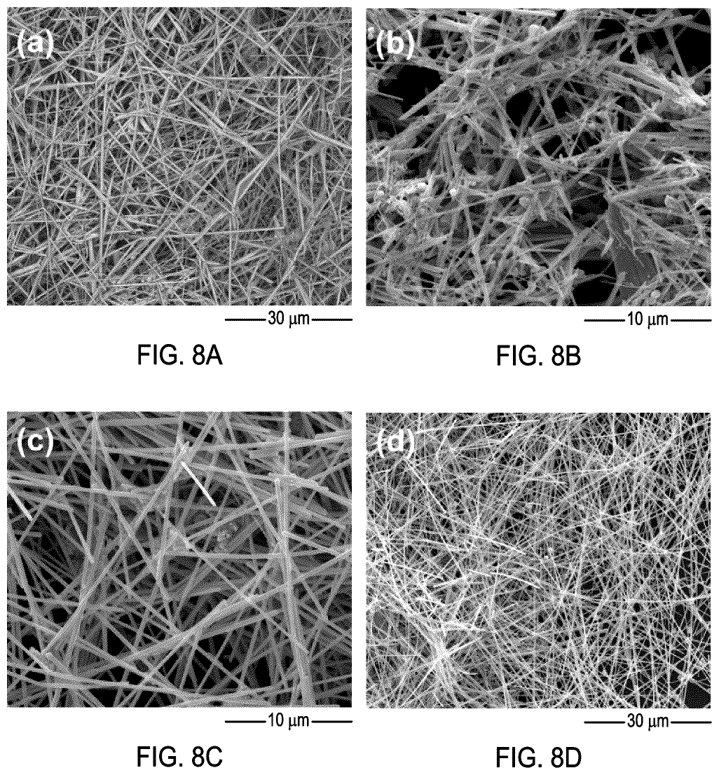

The method of Example 1 was performed with various HEC molecular weights. HEC with molecular weights of 380,000, 720,000, and 1,300,000 were used at the same concentration, and silver nanowires were still obtained. FIGS. 8A-8B illustrate SEM images of silver nanowires synthesized with HEC having a molecular weight of 380,000 and 720,000, respectively. The yield of nanowires decreased significantly when 1,300,000 molecular weight HEC was used, likely due to the extremely high viscosity of the reaction solution when high molecular weight HEC is present. Other solvents such as butanediol and glycerol were tested to replace ethylene glycol as the solvent medium, which successfully led to the production of silver nanowires. FIG. 8C illustrates a SEM image of silver nanowires synthesized using butanediol as the reaction solvent. FIG. 8D illustrates a SEM image of silver nanowires synthesized using a solvent mixture of 50 wt % ethylene glycol and 50 wt % glycerol as the reaction solvent.

### Example 6. Transparent Conductive Film Including Silver Nanowires

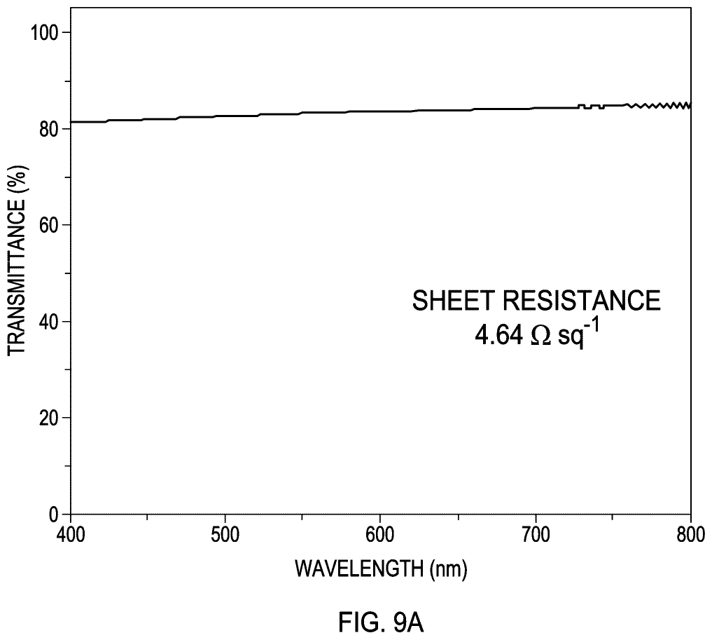

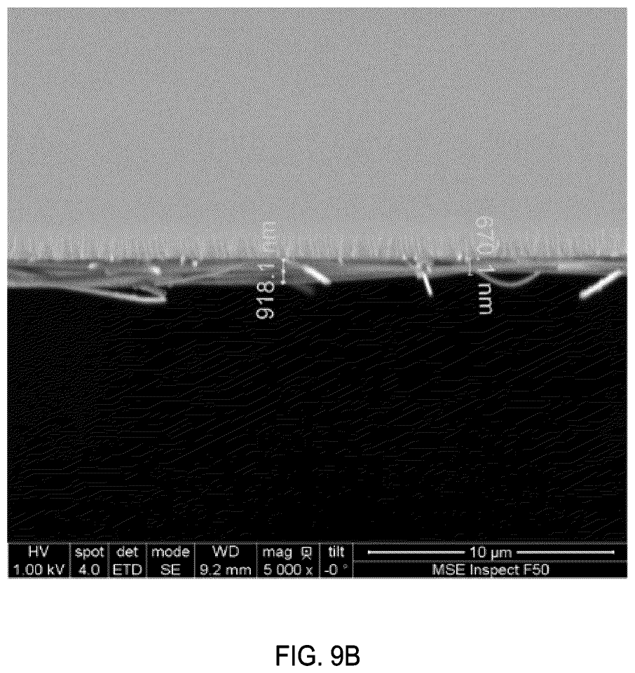

Silver nanowires are promising candidates for replacing conventional indium tin oxide in transparent conductive films. A silver nanowire solution was first prepared and a thin film was made by drop-casting the solution on a piece of glass slide. The solvent for the solution was water. The temperature used for drop-casting was 100° C. The conductivity of the thin film was evaluated by a four-point probe, giving a sheet resistance of 4.64 Ωsq⁻¹. The transmittance of the film was measured to be ˜80% at 550 nm by UV-vis spectroscopy (FIG. 9A). When silver nanowire film was placed on a piece of paper that included text, the text was clearly visible through the film, demonstrating the good optical transparency of the film. FIG. 9B illustrates a SEM cross-sectional image of the thin film on a glass slide shown in FIG. 9A. From the SEM cross-sectional image, the thickness of the film was measured as about 1 micron or less, which is consistent with the high transmittance observed. The performance of the film made from the silver nanowires was comparable to that from the conventionally synthesized silver nanowires using PVP.

### Example 7. Silver Nanostructures Synthesized Using Other Cellulose Derivatives

The method of Example 1 was followed using other cellulose derivatives, including hydroxypropyl cellulose (HPC), hydroxypropyl methyl cellulose (HPMC), and hydroxyethyl methyl cellulose (HEMC). With HPC, highly monodispersed nanocubes were synthesized. HPMC and HEMC both facilitated the formation of nanowires. The result indicates that the synthesis platform using cellulose derivatives is robust for the synthesis of silver nanostructures with tunable sizes and shapes.

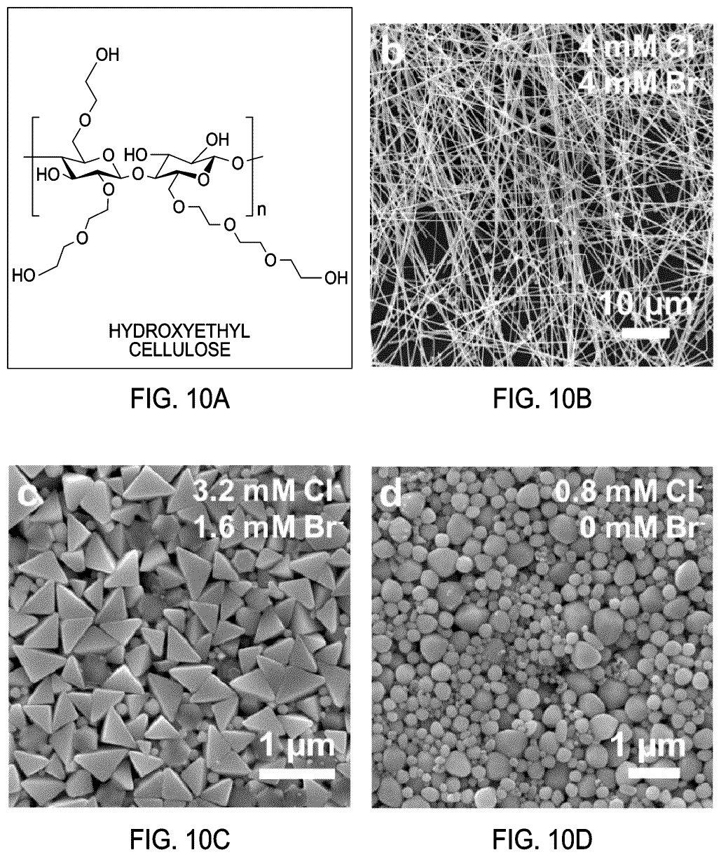

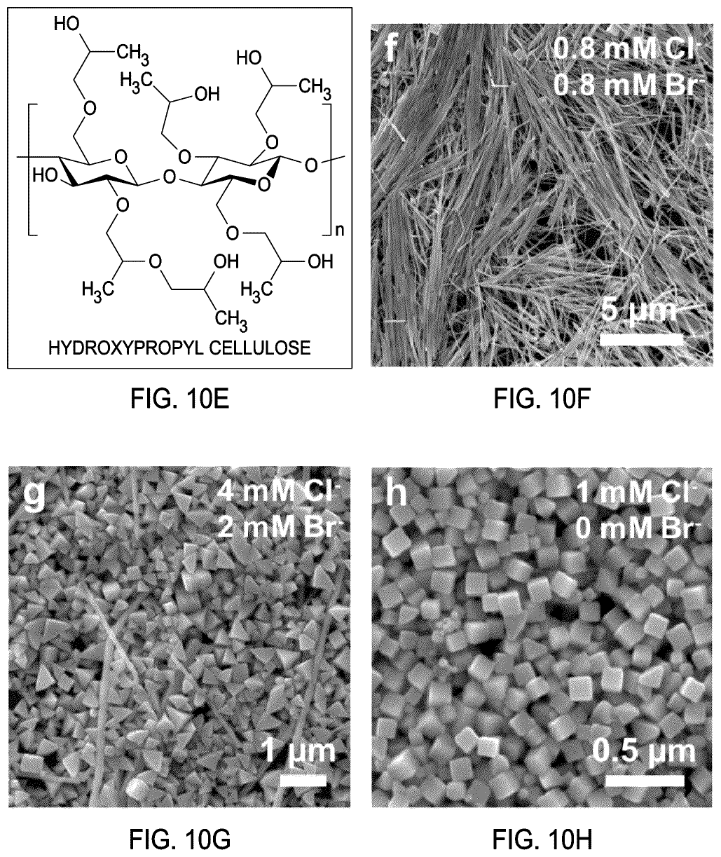

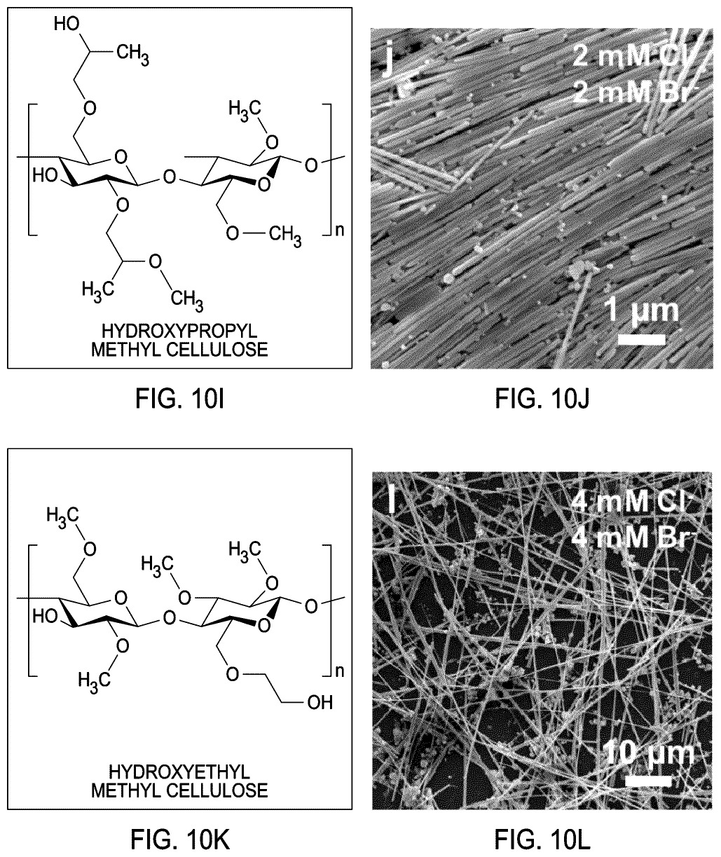

FIG. 10A illustrates the chemical structure of hydroxyethyl cellulose (HEC). FIG. 10B illustrates a SEM image of silver nanowires prepared using HEC and using a concentration of NaCl of 4 mM and a concentration of KBr of 4 mM. FIG. 10C illustrates a SEM image of silver bipyramids prepared using HEC and using a concentration of NaCl of 3.2 mM and a concentration of KBr of 1.6 mM. FIG. 10D illustrates a SEM image of faceted silver nanoparticles prepared using HEC and using a concentration of NaCl of 0.8 mM. FIG. 10E illustrates the chemical structure of hydroxypropyl cellulose (HPC). FIG. 10F illustrates a SEM image of silver nanowires prepared using HPC and using a concentration of NaCl of 0.8 mM and a concentration of KBr of 0.8 mM. FIG. 10G illustrates a SEM image of silver bipyramids prepared using HPC and using a concentration of NaCl of 4 mM and a concentration of KBr of 2 mM. FIG. 10H illustrates a SEM image of silver nanocubes prepared using HPC and using a concentration of NaCl of 1 mM. FIG. 10I illustrates the chemical structure of hydroxypropyl methylcellulose (HPMC). FIG. 10J illustrates a SEM image of silver nanowires prepared using HPMC and using a concentration of NaCl of 2 mM and a concentration of KBr of 2 mM. FIG. 10K illustrates the chemical structure of hydroxyethyl methylcellulose (HEMC). FIG. 10L illustrates a SEM image of silver nanowires prepared using HEMC and using a concentration of NaCl of 4 mM and a concentration of KBr of 4 mM.

### Example 8. Performance of Transparent Conductive Films Prepared from Silver Nanowires

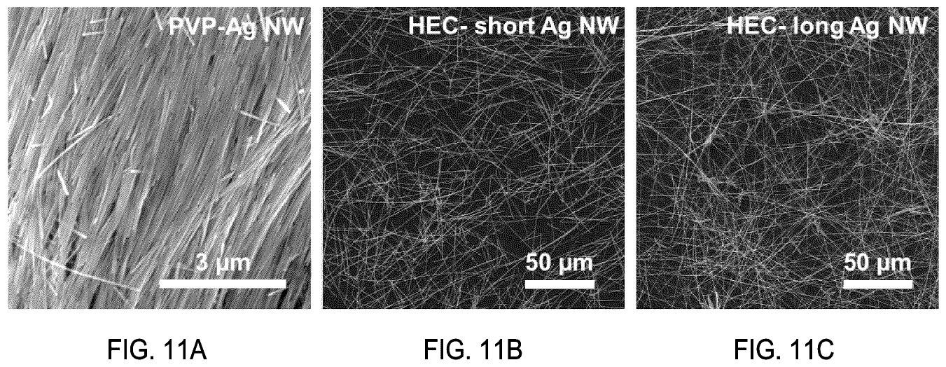

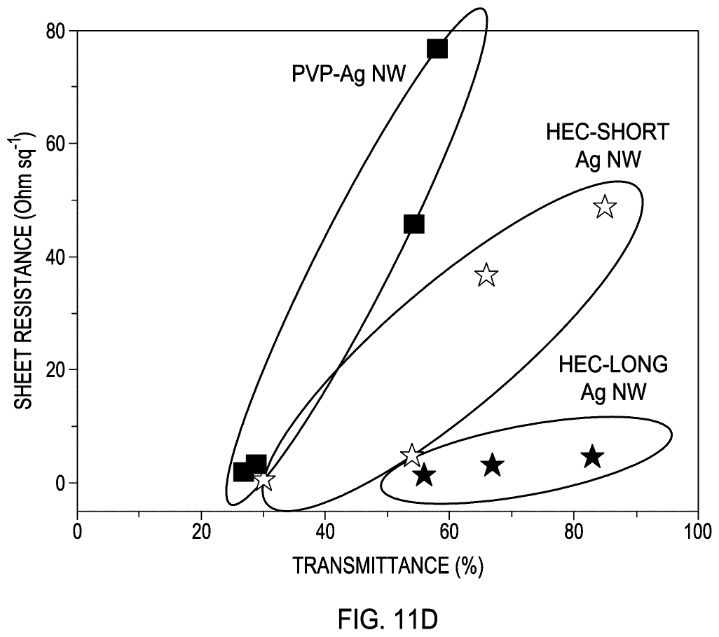

The performance of transparent conductive films prepared from silver nanowires which were synthesized either with PVP or HEC were compared. With HEC, long (>100 μm) and short (>50 μm) silver nanowires were used for comparison. The films were formed using the procedure of Example 6. FIG. 11A illustrates a SEM image of silver nanowires prepared using PVP. FIG. 11B illustrates a SEM image of silver nanowires prepared using HEC having a length of about 50 microns. FIG. 11C illustrates a SEM image of silver nanowires prepared using HEC having a length of greater than 100 microns.

FIG. 11D illustrates a plot of specular transmittance (2=550 nm) versus sheet resistance for films made from silver nanowires made using PVP, short silver nanowires made using HEC, and long silver nanowires made using HEC. long nanowires prepared using HEC resulted in the best film performance, giving a transmittance of ˜83% at 4.6 Ωsq⁻¹. In contrast, the sheet resistance of the film made from short silver nanowires prepared using HEC increased drastically to 48.8 Ωsq⁻¹ at a similar film transmittance. Silver nanowire films using nanowires prepared using PCP showed even higher sheet resistance at lower transmittance.

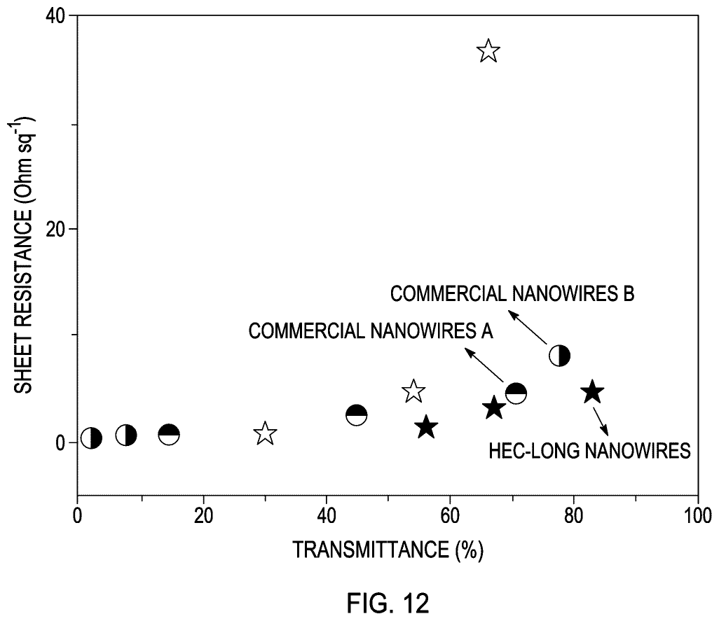

The performance of transparent conductive films prepared from synthesized silver nanowires and commercial silver nanowires were compared. Two types of commercial silver nanowires with dimensions of diam.×L 25 nm (±3 nm)×15 μm (±2 μm) and diam.×L 70 nm (±10 nm)×40 μm (±5 μm) were purchased from Sigma Aldrich. As shown in FIG. 12, the synthesized HEC-long nanowires (having a length of greater than 100 microns) outperformed both commercial products, as indicated by the higher transmittance of the film at a similar sheet resistance.

### Example 10. Optical Properties of Silver Nanostructures

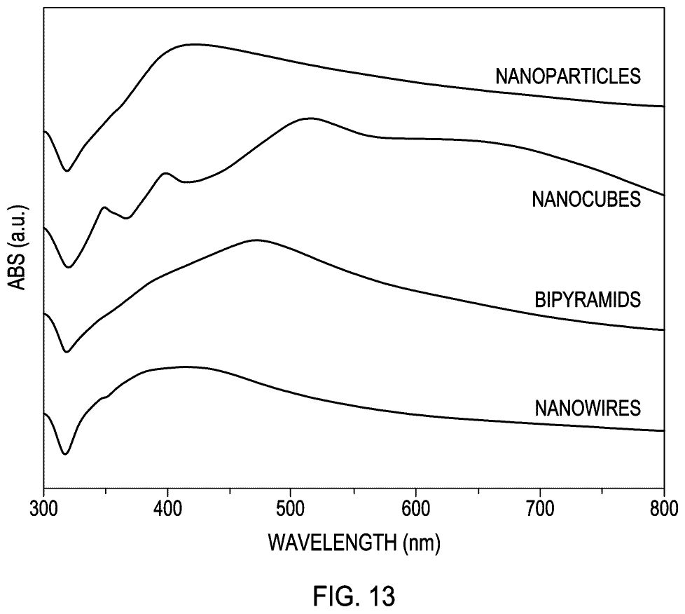

Additionally, optical properties of typical silver nanostructures synthesized with cellulose derivatives, including faceted nanoparticles, nanocubes, bipyramids, and nanowires were characterized by UV-vis spectroscopy (FIG. 13). All silver nanostructures synthesized with cellulose derivatives exhibited plasmonic properties consistent with those reported for silver nanostructures synthesized with PVP.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects.

The following exemplary aspects are provided, the numbering of which is not to be construed as designating levels of importance:

Aspect 1 provides a silver nanomaterial comprising:

silver nanowires or a particulate silver nanomaterial stabilized with cellulose or a cellulose derivative. The particulate silver nanomaterial can include, for example, silver bipyramids, silver nanocubes, or faceted silver nanoparticles.

Aspect 2 provides the silver nanomaterial of Aspect 1, wherein the cellulose or cellulose derivative at least partially coats the silver nanowires, or the particulate silver nanomaterial such as silver bipyramids, silver nanocubes, or faceted silver nanoparticles.

Aspect 3 provides the silver nanomaterial of any one of Aspects 1-2, wherein at least some of the cellulose or cellulose derivative is free and unbound to the silver nanowires, or to the particulate silver nanomaterial such as silver bipyramids, silver nanocubes, or faceted silver nanoparticles.

Aspect 4 provides the silver nanomaterial of any one of Aspects 1-3, wherein the cellulose derivative comprises hydroxymethyl cellulose, hydroxymethyl methylcellulose, hydroxyethyl cellulose, hydroxyethyl methylcellulose, hydroxypropyl cellulose, hydroxypropyl methylcellulose, sodium carboxymethyl cellulose (CMC) or methyl 2-hydroxyethyl cellulose (MHEC), or a combination thereof.

Aspect 5 provides the silver nanomaterial of any one of Aspects 1-4, wherein the cellulose derivative comprises hydroxyethyl cellulose.

Aspect 6 provides the silver nanomaterial of any one of Aspects 1-5, wherein the cellulose derivative has a weight-average molecular weight of 10,000 to 2,000,000.

Aspect 7 provides the silver nanomaterial of any one of Aspects 1-6, wherein the cellulose or cellulose derivative is a reducing agent for the synthesis of the silver nanowires, or the particulate silver nanomaterial such as silver bipyramids, silver nanocubes, or faceted silver nanoparticles, from a silver nanomaterial precursor.

Aspect 8 provides the silver nanomaterial of Aspect 7, wherein the silver nanomaterial precursor comprises silver nitrate, silver acetate, silver citrate, silver formate, silver carbonate, silver fluoride, silver nitrite, silver chloride, silver bromide, silver iodide, silver phosphate, silver oxide, silver hydroxide, silver acetate hydrate, or a combination thereof.

Aspect 9 provides the silver nanomaterial of any one of Aspects 7-8, wherein the silver nanomaterial precursor comprises silver nitrate.

Aspect 10 provides the silver nanomaterial of any one of Aspects 7-9, wherein the silver nanomaterial is substantially free of the silver nanomaterial precursor.

Aspect 11 provides the silver nanomaterial of any one of Aspects 1-10, further comprising a second reducing agent.

Aspect 12 provides the silver nanomaterial of Aspect 11, wherein the second reducing agent comprises ascorbic acid, sodium borohydride, hydrazine, or a combination thereof.

Aspect 13 provides the silver nanomaterial of any one of Aspects 1-12, further comprising one or more halides.

Aspect 14 provides the silver nanomaterial of Aspect 13, comprising chloride ions.

Aspect 15 provides the silver nanomaterial of any one of Aspects 13-14, comprising bromide ions.

Aspect 16 provides the silver nanomaterial of any one of Aspects 13-15, comprising chloride ions and bromide ions.

Aspect 17 provides the silver nanomaterial of Aspect 16, wherein a molar ratio of chloride ions to bromide ions is 10:1 to 1:10.

Aspect 18 provides the silver nanomaterial of any one of Aspects 16-17, wherein a molar ratio of chloride ions to bromide ions is 3:1 to 1:3.

Aspect 19 provides the silver nanomaterial of any one of Aspects 1-18, wherein the silver nanomaterial comprises the silver nanowires.

Aspect 20 provides the silver nanomaterial of Aspect 19, wherein the silver nanowires have a diameter of 20 nm to 500 nm.

Aspect 21 provides the silver nanomaterial of any one of Aspects 19-20, wherein the silver nanowires have a diameter of 100 nm to 200 nm.

Aspect 22 provides the silver nanomaterial of any one of Aspects 19-21, wherein the silver nanowires have a length of at least 1 micron.

Aspect 23 provides the silver nanomaterial of any one of Aspects 19-22, wherein the silver nanowires have a length of 1 micron to 10,000 microns.

Aspect 24 provides the silver nanomaterial of any one of Aspects 19-23, wherein the silver nanowires have a length of 50 microns to 500 microns.

Aspect 25 provides the silver nanomaterial of any one of Aspects 1-24, wherein the silver nanomaterial comprises the silver bipyramids, the silver nanocubes, or the faceted silver nanoparticles

Aspect 26 provides the silver nanomaterial of Aspect 25, wherein the silver bipyramids, the silver nanocubes, or the faceted silver nanoparticles have a largest dimension of 20 nm to 500 nm.

Aspect 27 provides the silver nanomaterial of any one of Aspects 25-26, wherein the silver bipyramids, the silver nanocubes, or the faceted silver nanoparticles have a largest dimension of 100 nm to 200 nm.

Aspect 28 provides a silver nanomaterial comprising silver nanowires stabilized with hydroxyethyl cellulose, wherein the nanowires have a length of at least 1 micron and a diameter of 20 nm to 500 nm; or a silver nanomaterial stabilized with cellulose or a cellulose derivative.

Aspect 29 provides a silver nanomaterial comprising:

silver bipyramids, silver nanocubes, or faceted silver nanoparticles stabilized with cellulose or a cellulose derivative;

wherein the silver bipyramids, silver nanocubes, or faceted silver nanoparticles have a largest dimension of 20 nm to 500 nm.

Aspect 30 provides a silver nanomaterial comprising a reaction product of a composition comprising:

a silver precursor;

cellulose or a cellulose derivative; and

halide ions.

Aspect 31 provides a silver nanomaterial comprising a reaction product of a composition comprising:

silver nitrate;

hydroxyethyl cellulose; and

a bromide salt and a chloride salt;

wherein the silver nanomaterial comprises a silver nanowire, or a particulate silver nanomaterial such as a silver bipyramid, silver nanocube, or a faceted silver nanoparticle.

Aspect 32 provides a conductive film comprising the silver nanomaterial of any one of Aspects 1-31.

Aspect 33 provides the conductive film of Aspect 32, wherein the conductive film is optically transparent.

Aspect 34 provides a method of making the silver nanomaterial of any one of Aspects 1-31, the method comprising:

forming a reaction solution comprising cellulose or a cellulose derivative and a silver nanomaterial precursor to form the silver nanomaterial.

Aspect 35 provides the method of Aspect 34, further comprising heating the reaction solution.

Aspect 36 provides the method of Aspect 35, wherein the heating comprises heating to a temperature of 50° C. to 250° C.

Aspect 37 provides the method of any one of Aspects 35-36, wherein the heating comprises heating to a temperature of 110° C. to 140° C.

Aspect 38 provides the method of any one of Aspects 35-37, wherein the heating comprises heating for a duration of 1 min to 24 h.

Aspect 39 provides the method of any one of Aspects 35-38, wherein the heating comprises heating for a duration of 1 h to 8 h.

Aspect 40 provides the method of any one of Aspects 34-39, further comprising agitating the reaction solution.

Aspect 41 provides the method of any one of Aspects 34-40, wherein the reaction solution further comprises a second reducing agent.

Aspect 42 provides the method of any one of Aspects 34-41, wherein the reaction solution further comprises a base.

Aspect 43 provides the method of Aspect 42, wherein the base comprises potassium hydroxide, sodium hydroxide, ammonium hydroxide, lithium hydroxide, or a combination thereof.

Aspect 44 provides the method of any one of Aspects 42-43, wherein a concentration of the base in the reaction solution is 0.1 mM to 10 mM.

Aspect 45 provides the method of any one of Aspects 42-44, wherein a concentration of the base in the reaction solution is 0.3 mM to 1 mM.

Aspect 46 provides the method of any one of Aspects 34-45, wherein the reaction solution further comprises one or more halide salts.

Aspect 47 provides the method of any one of Aspects 34-46, wherein the reaction solution further comprises a solvent.

Aspect 48 provides the method of Aspect 47, wherein the solvent comprises dimethyl sulfoxide (DMSO), water, ethylene glycol, butanediol, glycerol, diethylene glycol, triethylene glycol monomethyl ether (TGME), ethanol, acetone, butyl glycol acetate, carbitol acetate, glycol ether, ethyl glycol, dimethyl esters of adipic, glutaric, or succinic acids, or a combination thereof.

Aspect 49 provides the method of any one of Aspects 47-48, wherein the solvent has a boiling point of 100° C. or higher.

Aspect 50 provides the method of any one of Aspects 47-49, wherein the solvent comprises ethylene glycol.

Aspect 51 provides the method of any one of Aspects 47-50, wherein the reaction solution further comprises one or more halide salts.

Aspect 52 provides the method of Aspect 51, wherein the one or more halide salts comprise a bromide salt, a chloride salt, or a combination thereof.

Aspect 53 provides the method of any one of Aspects 51-52, wherein the one or more halide salts comprise a bromide salt and a chloride salt.

Aspect 54 provides the method of any one of Aspects 51-53, wherein the one or more halide salts comprise ammonium bromide, sodium bromide, potassium bromide, calcium bromide, aluminum bromide, ammonium chloride, sodium chloride, potassium chloride, calcium chloride, aluminum chloride, or a combination thereof.

Aspect 55 provides the method of any one of Aspects 51-54, wherein the one or more halide salts comprise KBr and NaCl.

Aspect 56 provides the method of any one of Aspects 51-55, wherein the reaction solution has a molar ratio of chloride ions to bromide ions of 10:1 to 1:10.

Aspect 57 provides the method of any one of Aspects 51-56, wherein the reaction solution has a molar ratio of chloride ions to bromide ions of 3:1 to 1:3.

Aspect 58 provides the method of any one of Aspects 51-57, wherein the reaction solution has a total concentration of the one or more halide salts of 0.1 mM to 20 mM.

Aspect 59 provides the method of any one of Aspects 51-58, wherein the reaction solution has a total concentration of the one or more halide salts of 1 mM to 10 mM.

Aspect 60 provides the method of any one of Aspects 51-59, wherein the reaction solution has a concentration of the cellulose or cellulose derivative of 1 mg/mL to 200 mg/mL.

Aspect 61 provides the method of any one of Aspects 51-60, wherein the reaction solution has a concentration of the cellulose or cellulose derivative of 1 mg/mL to 30 mg/mL.

Aspect 62 provides the method of any one of Aspects 34-61, further comprising purifying the silver nanomaterial.

Aspect 63 provides the method of any one of Aspects 34-62, wherein the reaction solution has a mass ratio of the silver nanomaterial precursor to the cellulose or cellulose derivative of 0.01:1 to 100:1.

Aspect 64 provides the method of any one of Aspects 34-63, wherein the reaction solution has a mass ratio of the silver nanomaterial precursor to the cellulose or cellulose derivative of 0.05:1 to 0.5:1.

Aspect 65 provides the method of any one of Aspects 34-64, wherein the cellulose or cellulose derivative has a weight-average molecular weight (Mw) of 10,000 to 2,000,000.

Aspect 66 provides the method of any one of Aspects 34-65, further comprising forming a conductive film that comprises the silver nanomaterial.

Aspect 67 provides the method of Aspect 66, comprising drop-casting a solution comprising the silver nanomaterial on a substrate, to form the conductive film on the substrate.

Aspect 68 provides the method of Aspect 67, wherein the substrate comprises glass.

Aspect 69 provides a method of making a silver nanomaterial, the method comprising:

heating a reaction solution comprising a solvent, hydroxyethyl cellulose, silver nitrate, a bromide salt, and a chloride salt and a silver nanomaterial precursor to a temperature of 110° C. to 140° C. to form the silver nanomaterial, wherein the reaction solution has a ratio of chloride ions to bromide ions of 10:1 to 1:10;

wherein the silver nanomaterial comprises a silver nanowire having a length of at least 1 micron and a diameter of 20 nm to 500 nm or a particulate silver nanomaterial such as a silver bipyramid, silver nanocube, or faceted silver nanoparticle having a largest dimension of 20 nm to 500 nm.

Aspect 70 provides a silver nanomaterial produced by the method of any one of Aspects 34-69.

Aspect 71 provides a silver nanomaterial comprising a reaction product of a reaction solution comprising:

silver nitrate;

a solvent;

hydroxyethyl cellulose; and

a bromide salt and a chloride salt, wherein the reaction solution has a ratio of chloride ions to bromide ions of 3:1 to 1:3.

Aspect 72 provides the silver nanomaterial, conductive film, or method of any one or any combination of Aspects 1-71 optionally configured such that all elements or options recited are available to use or select from.

What is claimed is:

1. A silver nanomaterial comprising:
silver nanowires, silver bipyramids, silver nanocubes, or faceted silver nanoparticles stabilized with cellulose or a cellulose derivative.

2. The silver nanomaterial of claim 1, wherein the cellulose or cellulose derivative at least partially coats the silver nanowires, silver bipyramids, silver nanocubes, or faceted silver nanoparticles.

3. The silver nanomaterial of claim 1, wherein the cellulose derivative comprises hydroxyethyl cellulose.

4. The silver nanomaterial of claim 1, wherein the cellulose derivative has a weight-average molecular weight of 10,000 to 2,000,000.

5. The silver nanomaterial of claim 1, wherein the cellulose or cellulose derivative is a reducing agent for the synthesis of the silver nanomaterial from a silver nanomaterial precursor, wherein the silver nanomaterial precursor comprises silver nitrate.

6. The silver nanomaterial of claim 5, wherein the silver nanomaterial is substantially free of the silver nanomaterial precursor.

7. The silver nanomaterial of claim 1, further comprising one or more halides.

8. The silver nanomaterial of claim 7, comprising chloride ions and bromide ions, wherein a molar ratio of chloride ions to bromide ions is 10:1 to 1:10.

9. The silver nanomaterial of claim 1, wherein the silver nanomaterial comprises the silver nanocubes and/or the faceted silver nanoparticles, wherein the silver nanocubes and the faceted silver nanoparticles have a largest dimension of 20 nm to 500 nm.

10. The silver nanomaterial of claim 1, wherein the silver nanomaterial comprises the silver nanowires, wherein the silver nanowires have a diameter of 20 nm to 500 nm, a diameter of 100 nm to 200 nm, and a length of 1 micron to 10,000 microns.

11. The silver nanomaterial of claim 1, wherein the silver nanomaterial comprises the silver bipyramids, wherein the silver bipyramids have a largest dimension of 20 nm to 500 nm.

12. A silver nanomaterial comprising a reaction product of a composition comprising:
a silver precursor; and
cellulose or a cellulose derivative; and
halide ions.

13. A conductive film including the silver nanomaterial of claim 1.

14. A method of making the silver nanomaterial of claim 1, the method comprising:
heating a reaction solution comprising cellulose or a cellulose derivative, a solvent, and a silver nanomaterial precursor to a temperature of 50° C. to 250° C. to form the silver nanomaterial.

15. The method of claim 14, wherein the solvent comprises ethylene glycol.

16. The method of claim 14, wherein the reaction solution further comprises one or more halide salts.

17. The method of claim 16, wherein the one or more halide salts comprise a bromide salt and a chloride salt.

18. The method of claim 16, wherein the reaction solution has a molar ratio of chloride ions to bromide ions of 10:1 to 1:10, and wherein the reaction solution has a total concentration of the one or more halide salts of 0.1 mM to 20 mM.

19. A method of forming a conductive film, the method comprising:
forming the conductive film from a composition that comprises the silver nanomaterial of claim 1.

20. A method of making a silver nanomaterial, the method comprising:
heating a reaction solution comprising a solvent, hydroxyethyl cellulose, silver nitrate, KBr, NaCl, and a silver nanomaterial precursor to a temperature of 110° C. to 140° C. to form the silver nanomaterial, wherein the reaction solution has a ratio of chloride ions to bromide ions of 10:1 to 1:10;
wherein the silver nanomaterial comprises a silver nanowire having a length of at least 1 micron and a diameter of 20 nm to 500 nm or a silver bipyramid, silver nanocube, or faceted silver nanoparticle having a largest dimension of 20 nm to 500 nm.
